(19) United States
(12) Patent Application Publication
(10) Pub. No.: US 2012/0031002 A1
(43) Pub. Date: Feb. 9, 2012

(54) APPARATUS AND METHOD FOR PREASSEMBLING, SHIPPING, AND INSTALLING A MOVABLE PARTITION SYSTEM

(75) Inventors: Craig G. Bell, South Jordan, UT (US); Michael E. Hazlett, Taylorsville, UT (US); Joe B. Lipscomb, Kearns, UT (US)

(73) Assignee: WON-DOOR CORPORATION, Salt Lake City, UT (US)

(21) Appl. No.: 12/851,346

(22) Filed: Aug. 5, 2010

(51) Int. Cl. E05D 15/06; B23P 17/00; B65B 5/00; E06B 7/00; E05F 15/06

(52) U.S. Cl. 49/70; 53/452; 29/428; 29/407.01

(57) ABSTRACT

An at least partially preassembled and packaged movable partition system is disclosed. The at least partially preassembled and packaged movable partition system includes a shipping box including a plurality of pocket walls defining a pocket therein, at least a portion of a track located within the pocket, the at least a portion of the track coupled to at least one pocket wall of the plurality of pocket walls, and a door coupled with the at least a portion of the track. Methods of packaging and installing an at least partially preassembled and packaged movable partition system are further disclosed herein.

### TECHNICAL FIELD

Embodiments of the present disclosure relate generally to movable partitions and, more particularly, to the preassembling, packaging and shipping of such partitions.

### BACKGROUND

Movable partitions are utilized in numerous situations and environments for a variety of purposes. Such movable partitions may include, for example, a partition barrier (e.g., foldable door, collapsible door, etc.) configured to at least partially enclose an area (e.g., a room). Although a “door,” a “partition,” and a “barrier” may each be examples of movable partitions, these terms may, at times, be used interchangeably with a movable partition. Often such movable partitions are utilized simply to subdivide a single large room within a building into multiple smaller rooms. The subdivision of a larger space may be desired, for example, to accommodate multiple groups or meetings simultaneously. Such movable partitions may be utilized for noise control depending, for example, on the activities taking place in a given room or portion thereof.

Movable partitions may also be used to provide a security barrier, a fire barrier, or a combination thereof. In such circumstances, the movable partition may be configured to automatically close upon the occurrence of a predetermined event such as the actuation of an associated alarm. For example, one or more movable partitions may be used as a security barrier, a fire barrier, or a combination thereof. Each movable partition may be formed with a plurality of panels connected to one another with hinges or some other connecting device. For example, the hinged connection of the panels allows the movable partition to fold and collapse into a compact unit for purposes of storage when not deployed. The movable partition may be stored, for example, in a pocket formed in the wall of a building when in a retracted state. If deployment of the movable partition is desired (e.g., to secure an area during a fire, subdivide an area, etc.), the movable partition may be extended along a track until the door is extended a desired distance across the room to form an appropriate barrier. The track may be an overhead track located above the movable partition on or in a header assembly.

When deployed, a leading end of the movable partition may complementarily engage with another structure, such as a wall, a post, or in a mating receptacle of another movable partition. The leading end of the movable partition may include or be defined by a component known as a “lead post.” The lead post may engage a door post (i.e., jamb) of a fixed structure, or a mating leading end of another door.

In operation, the movable partition may be retracted to a fully open, or partially open state. As used herein, “extension” or “extending” refers to movement of a movable partition toward a closed state, while “retraction” or “retracting” refers to movement of a movable partition toward an open state. Automatic extension and retraction of the movable partition may be accomplished through the use of a motor located in a pocket formed in the wall of a building in which the movable partition is stored when in a retracted or folded state. The motor, which remains fixed in place within the pocket, may be used to drive extension and retraction of the movable partition. A motor for automatically extending and retracting a movable partition may also be mounted within the movable partition itself, such that the motor travels with the movable partition as the movable partition is extended and retracted.

### BRIEF SUMMARY

Embodiments of the present invention include an at least partially preassembled and packaged movable partition system comprising a shipping box comprising a plurality of pocket walls defining a pocket therein, at least a portion of a track located within the pocket, the at least a portion of the track coupled to at least one pocket wall of the plurality of pocket walls, and a door coupled with the at least a portion of the track.

In additional embodiments of the present invention, a method of packaging at least a portion of a movable partition system is provided. The method comprises coupling together a plurality of pocket walls to define a box comprising a pocket therein, coupling at least a portion of a track to at least one pocket wall of the plurality of pocket walls, coupling at least a portion of a movable partition to the at least a portion of the track and disposing the movable partition within the box, and closing the box by coupling a wall to the plurality of pocket walls defining the box.

Yet further embodiments of the present invention includes a method of installing at least a portion of a movable partition system in a building. The method comprises mounting at least a portion of a track to a wall of a box, coupling at least a portion of a movable partion to the at least a portion of the track within the box, shipping the box with the at least a portion of the movable partion and the at least a portion of the track therein to a building, and securing at least a portion of the box to a wall of the building.

### BRIEF DESCRIPTION OF THE SEVERAL VIEWS OF THE DRAWINGS

While the specification concludes with claims particularly pointing out and distinctly claiming what are regarded as embodiments of the invention, the advantages of embodiments of the invention may be more readily ascertained from the description of embodiments of the invention when read in conjunction with the accompanying drawings, in which:

FIG. 1 illustrates an embodiment of a movable partition system that may be preassembled, packaged, and shipped in accordance with embodiments of methods of the present invention;

FIG. 2 illustrates a track assembly of the movable partition system of FIG. 1;

FIG. 3 illustrates a simplified overhead view of the movable partition system of FIG. 1;

FIG. 4A is a perspective view of a portion of the automatic drive mechanism of the movable partition system of FIG. 1 that is configured for driving a movable partition of the system;

FIG. 4B is a top view of a portion of the automatic drive mechanism of FIG. 4A showing the automatic drive mechanism coupled to a chain;

FIG. 5 illustrates an example of a preassembled portion of a movable partition system according to an embodiment of the present invention;

FIG. 6 is an exploded view of a shipping box which includes a preassembled, packaged portion of the movable partition system of FIG. 5;

FIG. 7 illustrates a shipping box including a preassembled, packaged portion of the movable partition system of FIGS. 5 and 6 with one panel removed from the package;

FIG. 8 illustrates a shipping box including the preassembled, packaged portion of the movable partition system of FIGS. 5 through 7 in a completely packaged state;

FIG. 9 illustrates a shipping box including the preassembled, packaged portion of the movable partition system of FIGS. 5 through 8 and an additional shipping box separate from the shipping box according to an embodiment of the present invention; and

FIG. 10 illustrates a cart configured for manipulating a shipping box including a preassembled, packaged portion of a movable partition system like that of FIGS. 5 through 9 according to an embodiment of the present invention.

### DETAILED DESCRIPTION

Illustrations presented herein are not meant to be actual views of any particular movable partition system, or component of a movable partition system, but are merely idealized representations which are employed to describe embodiments of the present invention. Additionally, elements common between figures may retain the same or similar numerical designation.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise, a set of elements may comprise one or more elements.

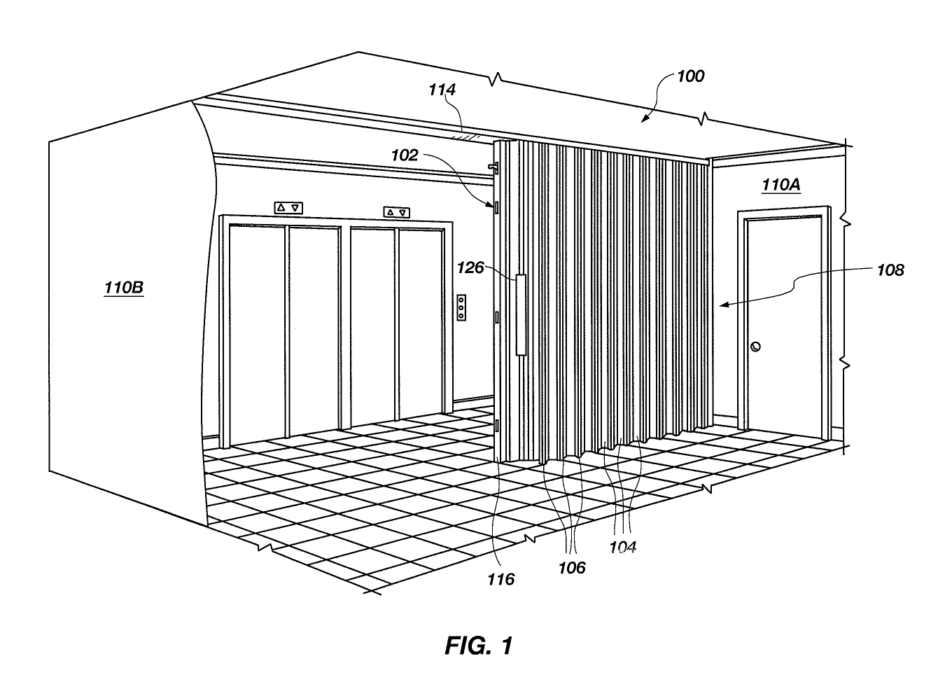

FIG. 1 illustrates an embodiment of a movable partition system 100, at least a portion of which may be preassembled, packaged, shipped, and installed in accordance with embodiments of methods of the present invention, as discussed in further detail below. FIG. 1 illustrates the movable partition system 100 fully installed for use within a building. The movable partition system 100 may be an automatic movable partition system, in that the movable partition system 100 includes a movable partition 102 that may be automatically extended, automatically retracted, or configured for a combination thereof. The movable partition 102 may also be manually extended, manually retracted, or configured for a combination thereof. In other words, the movable partition 102 may be moved both automatically and manually movable, as desired. The movable partition 102 may be used for partitioning space, as a sound barrier, as a fire barrier, as a security barrier, for combinations thereof, or for other purposes.

The movable partition 102 may comprise, for example, an accordion-type door, as shown in FIG. 1. The movable partition 102 may be formed with a plurality of panels 104 that are connected to one another with connectors 106 (e.g., hinges). The connection of the panels 104 allows the panels 104 to fold as the movable partition 102 is retracted. With the panels 104 folded, the movable partition may collapse and become more compact. Thus, when the movable partition 102 is in a compact (i.e., retracted) state, the movable partition 102 may be in an open state and stored off to the side of the area. In some embodiments, a movable partition 102 may be compactly stored (e.g., stacked) at least partially within a pocket 108 formed in a wall 110A of a building.

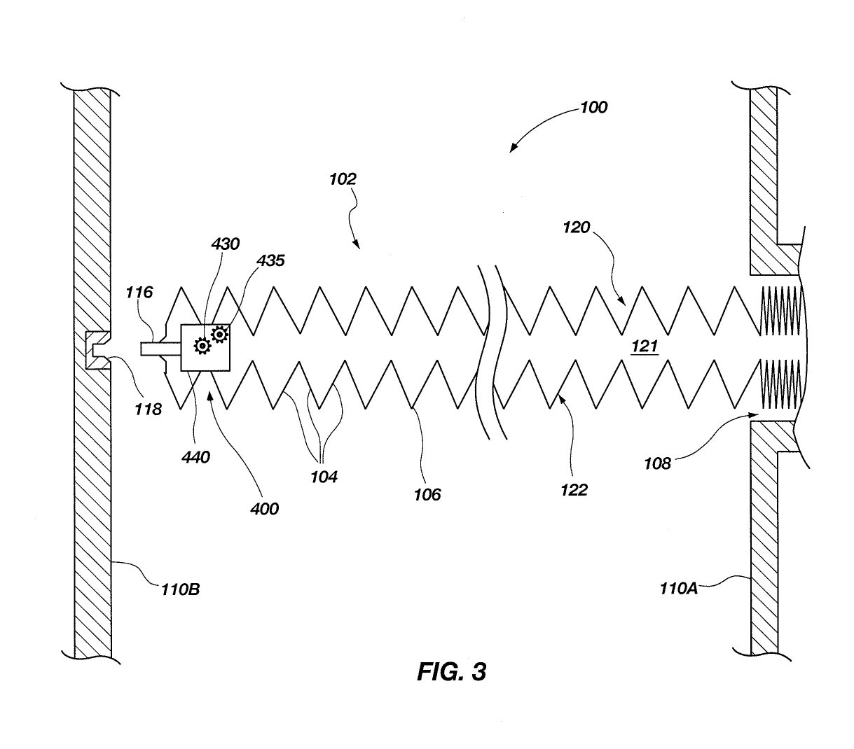

If it is desired to deploy the movable partition 102 to an extended position, the movable partition 102 may be extended along a track assembly 114 to provide an appropriate barrier. A leading end 116 of the movable partition 102 may be configured to complementarily (e.g., matingly) engage with another object when the movable partition 102 is in an extended state. For example, movable partition 102 may complementarily engage with a door post (see, e.g., FIG. 3). Such a door post may also be commonly referred to as a “jamb.” Such a door post may be formed in another wall 110B of a building as shown in FIG. 1.

The movable partition 102 may further include an actuator 126 (e.g., switch), which is commonly referred to as “panic hardware.” Such an actuator 126 may be desirable, for example, when the movable partition 102 is used as a fire door. The actuator 126 allows a person located on one side of the movable partition 102 to cause the door to be opened if it is closed, or to stop while it is closing, allowing egress through the barrier formed by the door as needed.

It is noted that the embodiment shown and described in FIG. 1 includes a single movable partition 102, wherein one end of the movable partition 102 is connected to or located proximate one wall 110A and extends entirely across an area within a building to another wall 110B for engagement thereto. However, other types of movable partitions may be used. For example, a two-door system may be utilized wherein two similarly configured doors extend across a space and join together to form an appropriate barrier. For example, the leading end 116 of the movable partition 102 may be configured to complementarily engage with an end of another movable partition, or some other structure. Complementarily engaging may include one end (e.g., leading end 116) being a male end and another end (e.g., door jamb or leading end of another movable partition) being a female end, or vice versa. Additionally, although movable partition 102 is shown as an accordion-type door in FIG. 1, the movable partition 102 is not so limited. The movable partition 102 may comprise another type of movable partition in additional embodiments of the invention.

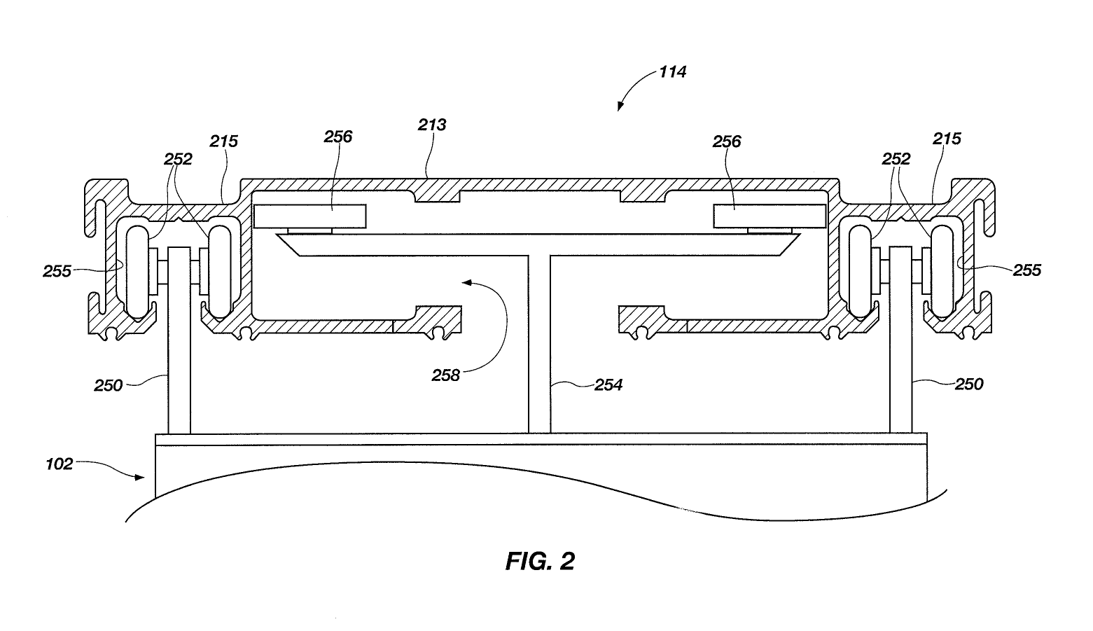

FIG. 2 illustrates a track assembly 114 of the movable partition system 100 of FIG. 1. The track assembly 114 may include an elongated central guide member 213, and a plurality of lateral guide members 215 disposed on opposite lateral sides of the elongated central guide member 213. The track assembly 114 may also be referred to herein simply as a “track.” In some embodiments, the elongated central guide member 213 and the plurality of lateral guide members 215 may comprise separate bodies or structures that are attached to one another, or simply installed proximate one another. In additional embodiments, the elongated central guide member 213 and the plurality of lateral guide members 215 may comprise different regions of a single, unitary body or structure.

The elongated central guide member 213 may comprise a hollow body having internal surfaces defining a drive channel 258 that extends longitudinally through the elongated central guide member 213. The drive channel 258 may be used to at least partially house drive mechanism components, alignment devices including rollers (e.g., wheels), etc., of the movable partition system 100, as described in further detail below.

Each of the plurality of lateral guide members 215 also may comprise a hollow body having internal surfaces defining roller channels 255 that extend longitudinally through the plurality of lateral guide members 215, respectively. The movable partition 102 may be suspended from (i.e., hang from) partition support members 250 and move along the track assembly 114 by the rolling of partition support rollers 252 (e.g., wheels) within and along the roller channels 255 that extend longitudinally through the plurality of lateral guide members 215 of the track assembly 114. The partition support rollers 252 may be coupled to partition support members 250 and, the movable partition 102 may be attached to and suspended from the partition support members 250.

The movable partition 102 may also be connected to an alignment device configured for ensuring that the movable partition 102 stays aligned with the track assembly 114 as the movable partition 102 is extended or retracted. For example, the alignment device may comprise an alignment frame structure 254 coupled to the movable partition 102. A portion of the alignment frame structure 254 may be disposed outside the drive channel 258, and another portion of the alignment frame structure 254 may be disposed within the drive channel 258, such that the alignment frame structure 254 extends through an opening in the elongated central guide member 213 leading to the drive channel 258.

The alignment device may further include alignment rollers 256 configured to roll along the elongated central guide member 213 within the drive channel 258. One or more alignment rollers 256 may be configured to roll along a vertical interior lateral wall of the elongated central guide member 213 within the drive channel 256. One or more alignment rollers 256 may also be configured to roll along an opposite vertical interior lateral wall of the elongated central guide member 213 within the drive channel 258. In other words, when the movable partition 102 is moved along the track assembly 114, the alignment device may roll or push against an internal surface of the elongated central guide member 213 keeping the movable partition 102 substantially aligned with the center of the track assembly 114. While a specific configuration of a track assembly 114 and alignment devices may be shown in FIG. 2, other configurations of track assemblies and alignment devices may be contemplated within embodiments of the present invention.

FIG. 3 schematically illustrates an overhead plan view of the movable partition system 100 of FIG. 1. As shown in FIG. 3, one end of the movable partition 102 may be connected with or extend to proximate a wall 110A of a building, such as to a location within a pocket 108 formed within the wall 110A. A leading end 116 of the movable partition 102 may be configured to complementarily engage with a door post 118 formed in an opposing wall 110B of the building when the movable partition 102 is in a deployed or an extended state. As previously mentioned, in additional embodiments, the leading end 116 of the movable partition 102 may complementarily engage with an end of another movable partition.

As shown in FIG. 3, the movable partition 102 be configured as an accordion-type door, which may include a plurality of panels 104. For example, one side of movable partition 102 may include a first sheet 120 of panels 104, and an opposite side of the movable partion 102 may include a second sheet 122 of panels 104. Such a configuration may be used as a fire door wherein one sheet (e.g., first sheet 120) acts as a initial fire and smoke barrier, the space 121 between the first sheet 120 and the second sheet 122 acts as a buffer zone (e.g., insulator), and the other sheet (e.g., second sheet 122) acts as a secondary fire and smoke barrier. Such a configuration may also be useful in providing an acoustical barrier or simply a physical barrier when the movable partition 102 is used to subdivide a larger area into a plurality of smaller areas.

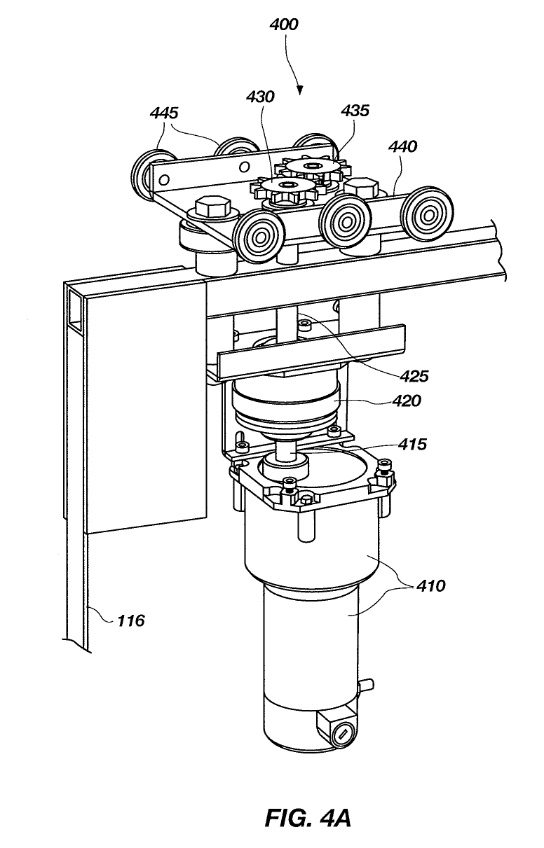

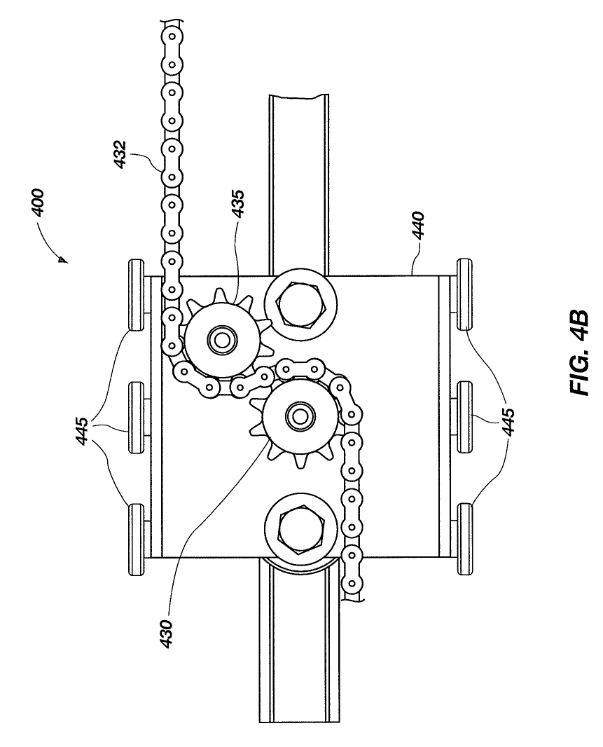

The movable partition system 100 may further include an automatic drive mechanism 400 configured to automatically open, automatically close, or configured for both upon actuation thereof. The automatic drive mechanism 400 may be located within the movable partition 102 (e.g., between the first sheet 120 and the second sheet 122) near the leading end 116 of the movable partition 102. The automatic drive mechanism 400 may include a rotatable drive member 430 connected to the drive shaft of a motor (not shown, see FIG. 4A), such that the motor may be configured to drive rotation of the rotatable drive member 430. The rotatable drive member 430 may be positioned within or adjacent a track assembly (see, e.g., FIG. 2, within the drive channel 258 of the track assembly 114), and may be configured to interact with an elongated drive member 432 (see FIG. 4B). The elongated drive member 432 may be configured as, or include, for example, a chain that may also be positioned within or adjacent the track assembly 142. The automatic drive mechanism 400 may be supported by support trolley 440.

FIG. 4A is a perspective view of a portion of the automatic drive mechanism 400 of the movable partition system 100 of FIG. 1 that is configured for driving a movable partition of the system. The automatic drive mechanism 400 may be configured to automatically open or close a movable partition upon actuation thereof. In other words, in operation, the automatic drive mechanism 400 may drive movement of the movable partition 102 along the track assembly 114 (FIG. 2).

The automatic drive mechanism 400 may include a motor 410, a clutch 420, a first drive shaft 415, a second drive shaft 425, and a rotatable drive member 430. The automatic drive mechanism 400 may be coupled with one or more support trolleys 440. Support trolleys 440 include trolley wheels 445 attached thereto. The trolley wheels 445 are configured to move the automatic drive mechanism 400 along the track assembly 114 of the movable partition system 100. The support trolley 440 and the trolley wheels 445 may be disposed fully or partially within the drive channel 258 in the track assembly 114 (FIG. 2). The support trolleys 440 may be located proximate the leading end 116 of the movable partition 102. As a result, such an automatic drive mechanism 400 may be called a lead post drive mechanism.

The motor 410 and the clutch 420 may be operatively connected with one another, such that the first drive shaft 415 of the motor 410 drives the rotation of the second drive shaft 425 of the clutch 420 when the clutch 420 is in an engaged state. The rotatable drive member 430 is connected to the second drive shaft 425 of the clutch 420, such that the motor 410 may be used to drive rotation of the rotatable drive member 430 when the clutch 420 is engaged. The rotatable drive member 430 may also be disposed within the drive channel 258 of the track assembly 114. An elongated drive member 432 (FIG. 4B), such as a chain, may be disposed within the track assembly so as to be engaged with the rotatable drive member 430.

The clutch 420 may be moved between an engaged state and a disengaged state. By way of example and not limitation, the first drive shaft 415 of the motor 410 may serve as the input to the clutch 420. The first drive shaft 415 of the motor 410 may be attached to a hub of the clutch 420. The second drive shaft 425 is output from the clutch 420 and may be driven by the motor 410 when the clutch 420 is in an engaged state. The second drive shaft 425 of the clutch 420 may not be driven by the motor 410 when the clutch 420 is in the disengaged state. In such a disengaged state, the second drive shaft 425 and the rotatable drive member 430 may rotate freely, without resistance from the motor 410. In other words, when the movable partition system 100 is in a disengaged state, the movable partition 102 may be moved along the track assembly manually, without resistance from the motor 410. Furthermore, in some embodiments, the clutch 420 may be in a partially engaged state, in which some of the rotation of the first drive shaft 415 of the motor 410 is transferred into rotation of the second drive shaft 425 of the clutch 420, but not all of the rotation is transferred. This engagement, disengagement, and partial engagement is accomplished by the normal operation of the clutch 420, as is well known in the art.

In operation, the motor 410 controls and drives rotation of the rotatable drive member 430. If the motor 410 is actuated and the clutch 420 is engaged, the first and second drive shafts 415, 425 cause the rotatable drive member 430 to rotate along the elongated drive member, the ends of which may be fixed in place. Thus, rotation of the rotatable drive member 430 causes the movable partition 102 to be extended or retracted along the track assembly 114, as the case may be depending on the desired direction of movement. The automatic drive mechanism 400 further includes a rotatable idler 435, which will be described with respect to FIG. 4B.

By way of example and not limitation, the motor 410 may include a 12-volt DC motor, such as those commercially available from Bodine Electric Company of Chicago, Ill. By way of example and not limitation, the clutch 420 may include a 12-volt DC electromagnetic clutch, such as the KEB CombiNorm Clutch commercially available from KEB America, Inc. of Shakopee, Minn. Of course, it will be appreciated by one of ordinary skill in the art that other components may be used for either the motor 410 or the clutch 420 in practicing the described embodiment. Furthermore, other mechanisms may be used for driving the movable partition along the track assembly, or for engaging and disengaging the drive shafts 415, 425 as related to the rotatable drive member 430, in place of or in addition to the motor 410 and clutch 420.

The automatic drive mechanism 400 may include various support mechanisms to support the weight of the different components of the automatic drive mechanism 400. Additionally, the automatic drive mechanism 400 may further include various sensors, switches, and controls to assist in the control of the movable partition 102 through appropriate connection with the automatic drive mechanism 400. For example, a position tracking device (not shown) may be used in conjunction with automatic drive mechanism 400 for identifying and/or tracking the position of at least a portion of a movable partition 102 along the track assembly 114. Examples of such different configurations of support mechanisms, sensors, switches, controls, and other related components that may be included with the automatic drive mechanism 400 or a movable partition system are described in U.S. patent application Ser. No. 12/542,448, which was filed Aug. 17, 2009 and entitled “Methods, Apparatuses, and Systems for Driving a Movable Partition,” and U.S. patent application Ser. No. 12/758,584, which was filed Apr. 12, 2010 and entitled “Methods, Apparatuses, and Systems for Movable Partitions,” the disclosures of each of which are incorporated herein in their entirety by reference. Other configurations of drive mechanisms may be contemplated for embodiments of the present invention, including those that move with the movable partition and those that are stationary within the pocket during movement of the movable partition.

FIG. 4B is a top view of a portion of the automatic drive mechanism 400 of FIG. 4A showing the automatic drive mechanism 400 coupled to an elongated drive member 432 configured as a chain. Automatic drive mechanism 400 may further include a rotatable idler 435, also coupled to the elongated drive member 432 (shown in FIG. 4B only). The elongated drive member 432 may extend at least partially around the rotatable drive member 430 and the rotatable idler 435. The rotatable idler 435 may rotate freely as the movable partition is moved along the track assembly either automatically or manually. The rotatable idler 435 may be positioned and configured to provide the proper tension and position of elongated drive member 432 so that rotatable drive member 430 may properly drive movement of movable partition along the track assembly. The automatic drive mechanism 400 may further include one or more additional rotatable idlers in addition to the rotatable idler 435. Other embodiments may not include a rotatable idler 435.

The elongated drive member 432 is illustrated in FIG. 4B as a chain and the rotatable drive member 430 as a sprocket. However, in other embodiments, the elongated drive member 432 may include a belt, cable, or rope and the rotatable drive member 430 may comprise a pulley, wheel, cog or other drive mechanisms for driving a movable partition along a track assembly (not shown, see FIG. 1). The elongated drive member 432 may be fixed at each end to respective ends of the effective length of track assembly. The elongated drive member 432 may be coupled to the rotatable drive member 430, such that rotation of the rotatable drive member 430 drives movement of the movable partition along the elongated drive member 432 and along the track assembly.

In accordance with embodiments of the present invention, movable partition systems, such as the movable partition system 100 of FIGS. 1 through 3, 4A and 4B, may be at least partially preassembled, packaged, and shipped in such a manner that facilities installation of the movable partition system for use within a building.

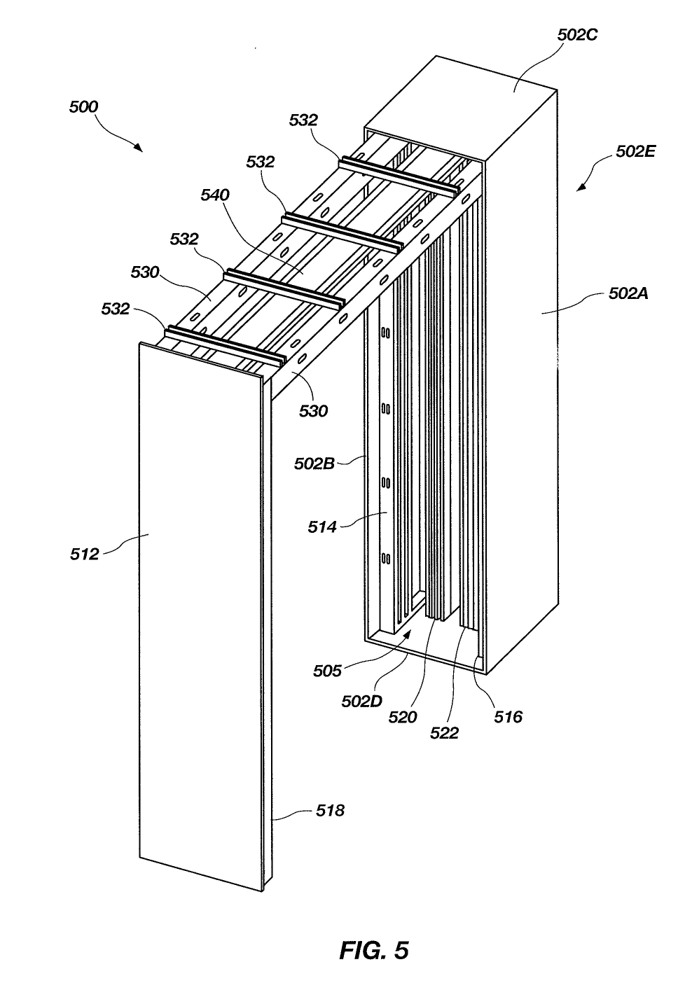

For example, FIG. 5 illustrates an example of a preassembled portion of a movable partition system 500 according to an embodiment of the present invention. The movable partition system 500 may be at least substantially similar to the movable partition system 100 previously described herein. The movable partition system 500 includes pocket walls 502A, 502,B . . . 502E that define a pocket 505 in which a movable partition may be stored. The pocket walls 502A, 502,B . . . 502E may ultimately be installed within a wall of a building in which the movable partition system 500 is to be installed, such that the pocket 505 is formed in the wall of the building and defined by the pocket walls 502A, 502,B . . . 502E. In FIG. 5, the movable partition system 500 may include a first sheet 520 and a second sheet 522 of panels. Other components, such as a lead post, rollers, trolleys, alignment features, automatic drive mechanisms, an elongate drive member (e.g., chain), etc. are not shown in FIG. 5 for simplicity.

The pocket walls 502A, 502B, . . . 502E may include lateral side walls 502A and 502B, a top wall 502C, a bottom wall 502D, and a back wall 502E. The pocket walls 502A, 502B, . . . 502E may be attached to wall support frame structures 514, 516, which may comprise a metal frame structure. For example, the lateral side wall 502B is attached to a wall support frame structure 514, and the lateral side wall 502A is attached to another wall support frame structure 516. Due to the perspective of the view of FIG. 5, another wall support frame structure to which the back wall 502E is attached is not visible. Pocket walls 502A, 502B, . . . 502E may be configured to couple with one or more walls or other structural members within a building in which the system 500 is to ultimately be installed for use, and may comprise a material such as plywood, for example.

The movable partition system 500 further includes a striker wall 512. The striker wall 512 may be coupled to a striker wall support frame structure 518, which may be at least substantially similar to the wall support frame structures 514, 516. The striker wall 512 may include a mating end (e.g., jamb), with which the sheets 520, 522 of panels may complementarily engage (e.g., through an end of a lead post). When the movable partition system 500 is ultimately installed in a building for use, the striker wall 512 may be located at an opposing end of the space that the movable partition system 500 is intended to subdivide, provide barriers, etc.

The movable partition system 500 includes a track 540 that extends between the pocket 505 and the striker wall 512. The track 540 may be configured to guide the sheets 520, 522 of panels when the sheets 520, 522 of panels are extended or retracted. The track 540 may be supported by support beams 530 and cross support structures 532, which may be configured to support the weight of the sheets 520, 522 of panels and other components (e.g., motor drive mechanisms, support trolleys, electronic components, etc.) when a movable partition is suspended from the track 540.

When in a retracted state, the sheets 520, 522 of panels may be collapsed and stored within the pocket 505. If the sheets 520, 522 of panels are extended, the sheets 520, 522 of panels may extend up to the striker wall 512 for complementarily engaging the mating ends in the lead post and the striker wall 512.

The height and length of a movable partition system 500 may vary depending on the dimensions of the room in which the movable partition system 500 is to be installed. As a result, the height and depth of the pocket 505 may also vary. For example, the depth of the pocket 505 may be approximately the distance needed in order for the sheets 520, 522 of panels to be disposed within the pocket 505 when the sheets 520, 522 of panels are collapsed. For rooms that are relatively long and require long sheets 520, 522 of panels, it may be desirable to have a portion of the collapsed sheets 520, 522 of panels be located out of the pocket 550 as opposed to forming an extremely deep pocket 505. During shipping, a portion of the sheets 520, 522 of panels (e.g., those located out of the pocket 550) may be shipped in shipping box separate from the shipping box including a pre-hung operational door as will be described below.

As previously discussed, a movable partition system 500 may conventionally be shipped to an installation location in an unassembled state, with each component or subsystem of the movable partition system 500 being shipped in separate boxes for assembly and installation at the site at which the movable partition system 500 is to be installed. For example, sheets 520, 522 of panels for a movable partition may be included and shipped in a box. The support beams 530 may be shipped in a different box. The motor drive system may be shipped in a different box. The track 540 may be shipped in a different box, and so on. The contents of each box may include groups of similar components that individually have manageable weights that one or two people may lift and transport around the installation location. While each component or subsystem may be independently tested for quality control purposes, the operation of the integration of the components as part of an operational door may not be tested until assembly and installation at the installation location. Additionally, because the conventional assembly and installation of a movable partition system 500 may include a kit of discrete parts in a knock down format, the assembly and installation at the installation location may need to be performed by technicians with specialized training (e.g., employees of the manufacturer rather than employees of the contractor). Such assembly and installation by technicians with specialized training may need to be performed at the installation location, which may require significant travel and expenses.

However, according to embodiments of the present invention, in preparation for shipping, one or more portions of the movable partition system 500 may be preassembled, and may be in an at least partially operational state in a separate facility (e.g., a manufacturing facility) prior to shipping to an installation location, rather than being first assembled at the installation location. As a result, installation of the movable partition system 500 at the installation location may be relatively simplified, may require fewer hours of labor, and may be performed by persons that do not have specialized training. Any final installation procedures that may remain to be completed at the installation location may be simplified to the point that instructions (e.g., written instructions, video instructions, etc.) may accompany the shipped movable partition system 500, such that a contractor with less specialized knowledge may be able to install the movable partition system 500 with little help from the manufacturer.

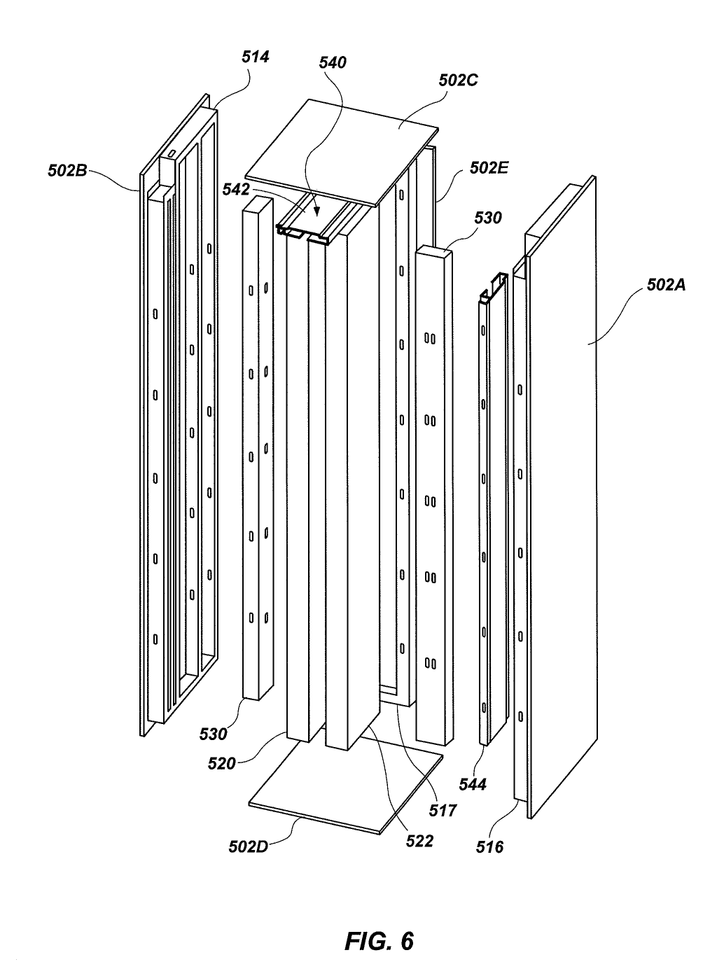

The pocket walls 502A, 502B, . . . 502E of the movable partition system 500 may be used to form a box or container 600, which is shown in an exploded view in FIG. 6, in which at least a portion of the movable partition system 500 may be preassembled and shipped to a location at which the movable partition system 500 is to be installed for use.

FIG. 6 is an exploded view of a preassembled, packaged portion of the movable partition system of FIG. 5 including a shipping box 600. The shipping box 600 includes a pocket 505 defined by the pocket walls 502A, 502B, . . . 502E, and a door housed within the pocket 505. The door may include the sheets 520, 522 of panels, which may be coupled with and hang from at least a portion of the track 540. In other words, the door may be pre-hung from preinstalled support structures (not shown). The door may further be operational in that the door may be coupled with an automatic drive mechanism (not shown) or at a sufficient stage in the assembly such that the door may be considered operational. As a result, the door, when preassembled within the shipping box 600, may also be referred to herein as a pre-hung operational door. It should be noted that a door may be operated automatically or manually. As a result, the term “pre-hung operational door” does not imply being coupled with an automatic drive mechanism unless otherwise specified herein.

The automatic drive mechanism may include components similar to those described with reference to FIGS. 2, 3, 4A and 4B. For example, the automatic drive mechanism may be configured such that a motor moves along with the sheets 520, 522 of panels. Examples of such an automatic drive mechanism are shown with reference to FIGS. 3, 4A and 4B, which automatic drive mechanism may be referred to as a lead post drive. A lead post drive may be positioned between sheets 520, 522 of panels, and may further be positioned proximate the front of the sheets 520, 522 of panels where the lead post may be located. Alternatively, the automatic drive mechanism may be pre-installed to include a motor located within the pocket 505 and attached to the back wall 502E behind the ends of the sheets 520, 522 of panels. Such an automatic drive mechanism may include a motor that is stationary relative to the movement of the sheets 520, 522 of panels. The pre-hung operational door may further include other preassembled components such as internal stabilizers, electronic control devices, as well as the lead post coupled with the leading ends of sheets 520, 522 of panels.

Some of the empty space surrounding the pre-hung operational door may be used to store other components of the movable partition system within the shipping box 600. For example, empty space may be located between the sheets 520, 522 of panels and the respective lateral side walls 502A, 502B. Empty space may also be located between the sheet 520 of panels and the sheet 522 of panels. Such other components may not be preassembled, and may be assembled at the installation location. As an example, a first support beam 530 may be located within the shipping box 600 between the sheet 520 of panels and the lateral side wall 502B. A second support beam 530 may be located within the shipping box 600 between the sheet 522 of panels and the lateral side wall 502A.

The track 540 may comprise a plurality of sections of track that are ultimately installed in an end-to-end configuration. A first track portion 542 may be attached to the top wall 502C and support the pre-hung operational door in its retracted state. At least a second track portion 544 may be detached from the first track portion 542 and located in an open area of space within the shipping box 600, such as between the sheet 522 of panels and the lateral side wall 502A. Of course, the specific locations illustrated in FIG. 6 for storing components for shipping is not intended to be limiting. In other words, the locations for any of the support beams 530, the second track portion 544, or other components of the movable partition system 500 may be any location where enough empty space exists to accommodate such a component. For example, the second portion of the track 544 may be located within the shipping box 600 between the back wall 502E and the ends of the sheets 520, 522 of panels.

In some situations, the length of the second track portion 544 and the length of the support beams 530 may exceed the height of the shipping box 600. In such a situation, or for other reasons, the second track portion 544 may separate into a plurality of sub-portions that may be disposed within the shipping box 600. One or more track portions or beam portions may also be shipped in an additional shipping box that is separate from the previously described shipping box. Embodiments that include more than one shipping box will be described in further detail below.

Other components such as the lead post, cross support structures 532, elongated drive member (e.g., chain), tensioners for the elongated drive member, battery, or other associated hardware for connecting the components of the movable partition system may also be located within empty space within the shipping box 600, or within another box separate from the shipping box 600.

When the shipping box 600 is opened at the installation location, the final installation may include connecting the second track portion 544 with the first track portion 542 (and any other additional portions of the track). The completed track 540 may extend between the pocket 505 and the opposing side of the room where the striker wall 512 is installed. The support beams 530 may similarly be installed. The other components that were not preassembled may also be installed in the appropriate manner.

As a result, the pre-hung operational door may be pre-assembled prior to shipping. The pre-hung operational door may also permit the automatic drive system, the controller, and the appropriate wiring to be preassembled in a controlled environment rather than at the installation location. As a result, the pre-hung operational door may be preassembled and tested prior to shipping by skilled personnel to ensure that the components and subsystems operate together in a satisfactory manner prior to shipping.

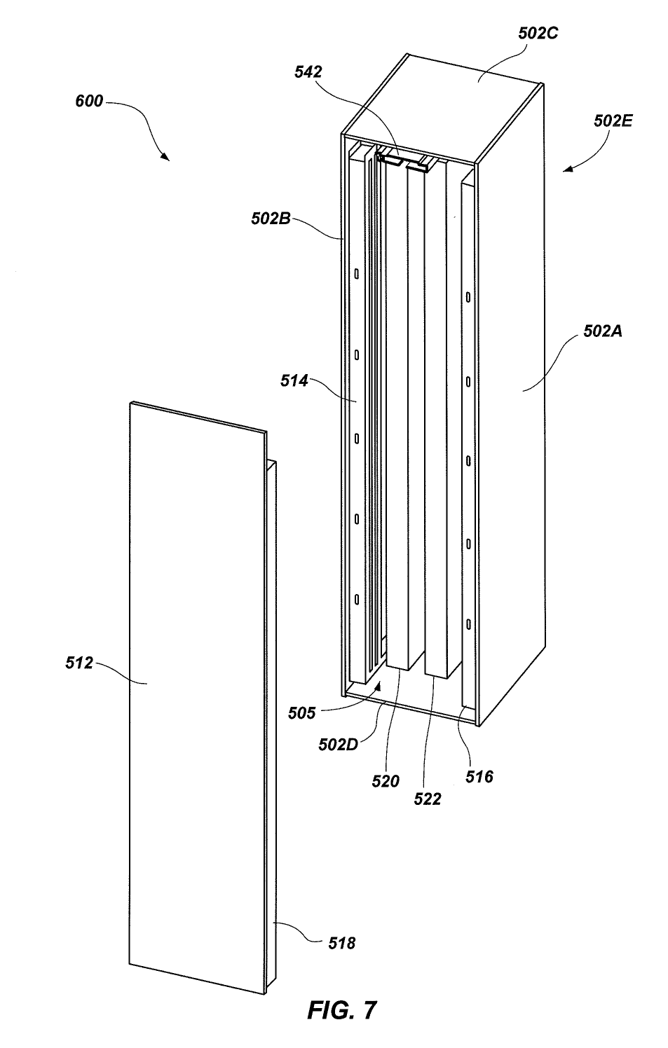

FIG. 7 illustrates a shipping box 600 including the preassembled, packaged portion of the movable partition system of FIGS. 5 and 6 with one panel removed from the package. In other words, FIG. 7 illustrates the shipping box 600 of FIG. 6 in a partially dosed state, but for the striker wall 512 and the striker wall support frame structure 518.

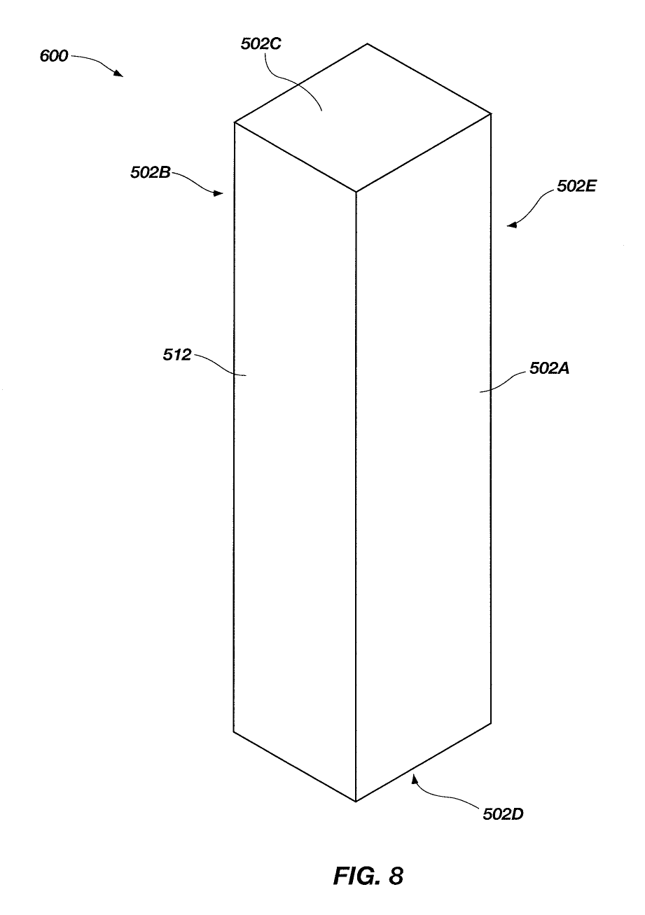

As shown in FIG. 7, the pocket walls 502A, 502B, . . . 502E and the striker wall 512 of the movable partition system combine to form the outer walls of the shipping box 600. Once the contents of the shipping box 600 are all in place, the striker wall 512 may be secured to the pocket walls 502A, 502B, . . . 502E in order to close the pocket 505 and form the completed shipping box 600, as shown in FIG. 8.

FIG. 8 illustrates a shipping box 600 including the preassembled, packaged portion of the movable partition system of FIGS. 5 through 7 in a completely packaged state. As described above, in some embodiments, the present invention includes a pre-hung operational door contained within a shipping box 600. The shipping box 600 may include other components for a movable partition system 500 within the spaces around the pre-hung operational door within the shipping box 600. In one embodiment, the entire movable partition system 500 may be self contained within a single shipping box 600. That is, each and every component of a movable partition system needed for assembly and installation at the installation location may be part of the single shipping box 600.

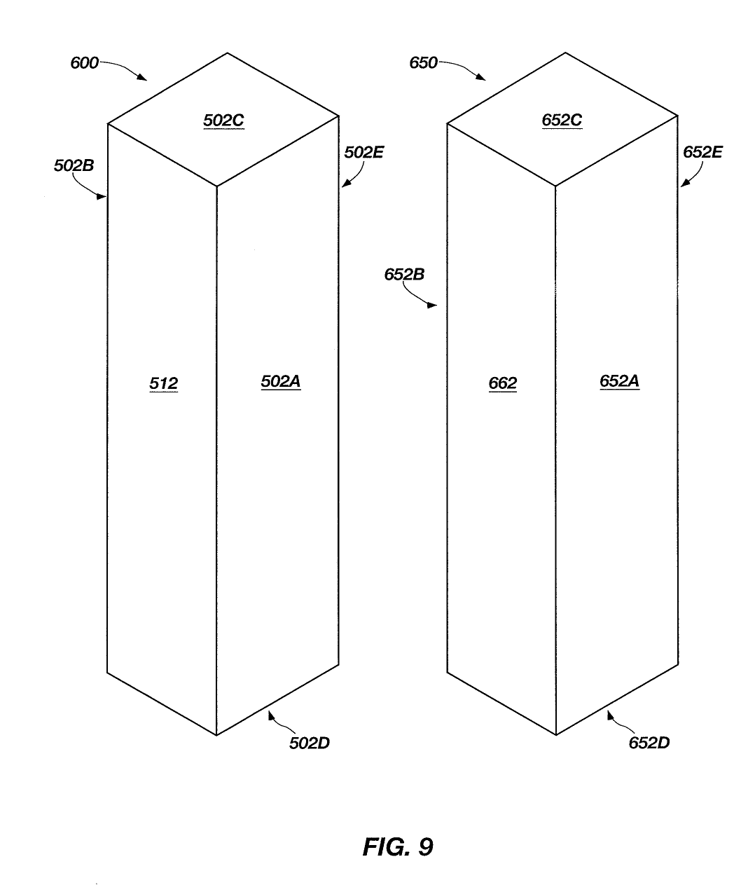

In additional embodiments, such as is shown in FIG. 9, not all components of the movable partition system may be included within a single shipping box, and some components may be shipped in an additional shipping box. FIG. 9 illustrates a shipping box 600 including the preassembled, packaged portion of the movable partition system 500 of FIGS. 5 through 8 and an additional shipping box 650 separate from the shipping box 600 according to an embodiment of the present invention.

In some embodiments, the shipping box 600 includes a pre-hung operational door within a pocket defined by pocket walls 502A, 502B . . . 502E, which pocket is closed off by striker wall 512 to form shipping box 600 as previously described herein. The first shipping box 600 may include further include some additional components of the system therein. Additionally, an additional shipping box 650, separate from the shipping box 600, may be included for packaging and shipping some other components of the movable partition system 500. Although the shipping box 600 and the additional shipping box 650 are shown as having similar dimensions, the shipping box 600 and the additional shipping box 650 may have substantially different dimensions, including height and width. The materials used for the shipping box 600 and the additional shipping 650 may also be the same, or different, as the case may be. Although one additional shipping box 650 is shown in FIG. 9, one or more additional shipping boxes may be included in embodiments of the present invention.

As previously described, an additional shipping box 650 may be employed, for example, if the length of the movable partition system 500 is overly great such that the length of the track 540 and the support beams 530 may be longer than the height of the pocket 505 of shipping box 600. In that situation, the track 540 and support beams 530 may be shipped in an additional shipping box 650 separate from the shipping box 600 with the pre-hung operational door, wherein the additional shipping box 650 has a length sufficient to contain the longer track 540 and support beams 530. Alternatively, the track 540 and support beams 530 may be separated into sufficiently small sub-portions to be disposed in the shipping box 600 and other components shipped in the another shipping box 650. Of course, the track 540 and support beams 530 may be separated into one or more portions that are sufficiently small for the shipping box 600 and nevertheless be packaged in an additional shipping box 650 separate from the shipping box 600.

Likewise, as previously discussed, in some embodiments, the depth of the pocket 505 may be approximately proportional to the length of the sheets 520, 522 of panels in the collapsed state. As a result, the collapsed sheets 520, 522 of panels may be completely housed within the pocket 505. In some embodiments, the length of the collapsed sheets 520, 522 of panels may be greater that the desired depth of the pocket 505. As a result, a portion of the collapsed sheets 520, 522 of panels may not be contained entirely within the pocket 505, and, therefore, also within the shipping box 600. Thus, a portion of the sheets 520, 522 of panels may be detachable, and may be removed from the remainder of the sheets 520, 522 of panels that remain as part of the pre-hung operational door. The portion of the sheets 520, 522 of panels that are detached may be disposed within empty space within the shipping box 600, if sufficient empty space exists, or within an additional shipping box 650 separate from the shipping box 600. A portion of the sheets 520, 522 of panels may be included in the additional shipping box 650 for other reasons as well.

For embodiments that include a multi-door movable partition system rather than a single door connecting with the striker wall, a plurality of shipping boxes may be employed that each include pre-hung operational doors within a pocket defined by pocket walls for the respective pre-hung door. For example, both the shipping box 600 and the another shipping box 650 may include pre-hung operational doors, with pocket walls 502A, 502B . . . 502E defining the pocket housing the first pre-hung operational door and forming the walls for shipping box 600, and walls 652A . . . 652E defining the pocket housing the second pre-hung operational door and forming the walls for the another shipping box 650. In such an embodiment in which two doors may mate rather than one door mating with an opposing wall, a striker wall may not be necessary. As a result, the final wall (e.g., wall 512 for shipping box 600 and wall 662 for shipping box 662) for each shipping box may simply be formed by a piece of wall material, such as a piece of plywood that may be discarded after shipment to the installation location.

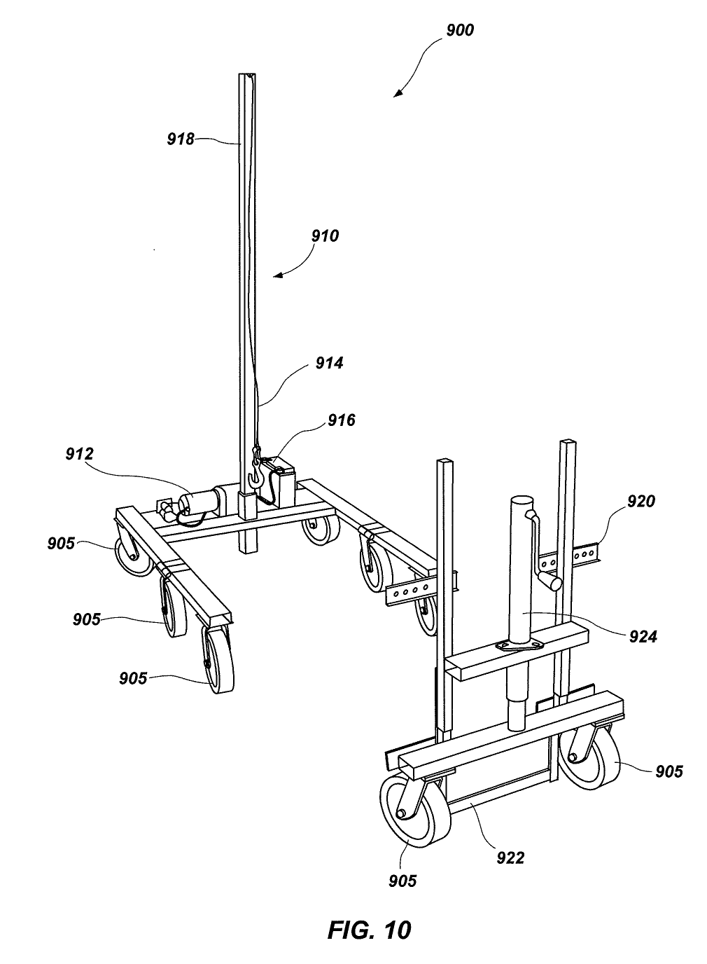

FIG. 10 illustrates a cart 900 configured for manipulating a shipping box 600 including a preassembled, packaged portion of a movable partition system like that of FIGS. 5 through 9 according to an embodiment of the present invention. In conventional shipping methods for a movable partition system 500, the plurality of boxes may be limited by weight, by size, or both, in order to be manageable for one or two people to manipulate and transport around the installation location. Embodiments of the present invention may include a shipping box including a preassembled pre-hung operational door that is relatively heavy and/or large, such that it might be relatively difficult for a single person or two persons to manipulate at an installation location, and, particularly, for transporting to upper floors of a building. For example, a shipping box including a pre-hung operational door may have a weight between about 600 pounds and about 900 pounds. The cart 900, therefore, is a tool configured for manipulating a shipping box 600 containing an at least partially assembled movable partition system 500 therein. The cart 900 may be configured to assist in moving the shipping box 600 around, standing up the shipping box 600, and otherwise positioning the shipping box 600 for installation by a reduced number of people without the assistance of a crane or forklift.

The cart 900 may include a first portion 910 and a second portion 920. The first portion 910 may include a motor 912 coupled with a cable 914 and a connector 916. The cable 914 may be threaded over an elongate member 918 of the first portion 910 for creating leverage for lifting at least a portion of the shipping box 600 in a vertical direction. The second portion 920 of the cart 900 may include a lift tray 922 and a jack 924 for lifting at least a portion of the shipping box 600 in a vertical direction. The first portion 910 may generate a lifting force on the shipping box 600 from above the shipping box 600, while the second portion 920 may generate a lifting force on the shipping box 600 from below the shipping box 600. Of course, the first portion 910 and second portion 920 may each include a combination of a motor 912, elongate member 918, cable 914, connector 916, lift tray 922, and jack 924. Each of the first portion 910 and second portion 920 of the cart 900 includes wheels 905.

In operation, the first portion 910 and the second portion 920 may be positioned on opposing ends of the shipping box 600. With the shipping box 600 lifted from the ground, the wheels 905 for each of the first portion 910 and the second portion 920 of the cart 900 may allow the shipping box 600 to be manipulated along the ground with a reduced friction. This relatively horizontal movement may allow the shipping box 600 to be more easily positioned at different locations in a room.

While the shipping box 600 is in a relatively horizontal position, the connector 916 may be placed within a mating feature of the shipping box 600, such as a hole formed through one of the pocket walls 502A, 502,B . . . 502E. In the embodiment shown in FIG. 9, the connector 916 comprises a hook, although the hook could include another type of connector. When the motor 912 is actuated, the cable 914 attached to the connector 916 retracts causing the shipping box 600 to be lifted upward, such as to tip the box 600 upward in the vertical direction. As a result, the motor 912 may cause the cable 914 and connector 916 to pull an end of the shipping box 600 up to a height at or near a tipping point sufficient for a person to push the shipping box past the tipping point and into a vertical position.

The cart 900, therefore, may be used to assist in the installation of the movable partition system 500 at the installation location so that installation of the movable partition system 500 may be performed relatively late in the overall building construction process, when options such as a crane or a forklift are no longer practical or available for transporting the shipping box 600 to an upper level of the building. The cart 900 may be formed from materials with a sufficient strength to support the weight of the shipping box. For example, the cart 900 may comprise a metal or a metal alloy such as steel or aluminum.

With the shipping box 600 in the vertical orientation and at a desired location (e.g., approximate location for the pocket of the movable partition system to be installed), the striker wall 512 may be removed from the shipping box 600 in order to expose the internal pocket 505 and contents of the shipping box 600. The pocket walls 502A, 502,B . . . 502E and striker wall 512 may then be installed in the appropriate location of the building. Any loose components (e.g., track, lead post, support beams, elongate drive member, etc.) within the pocket 505 may also be removed and installed in an appropriate manner. As a result, a movable partition system 500 like that previously described herein may be installed within a building.

While the present invention has been described herein with respect to certain preferred embodiments, those of ordinary skill in the art will recognize and appreciate that it is not so limited. Rather, many additions, deletions, and modifications to the preferred embodiments may be made without departing from the scope of the invention as hereinafter claimed. In addition, features from one embodiment may be combined with features of another embodiment while still being encompassed within the scope of the invention as contemplated by the inventors.

1. An at least partially preassembled and packaged movable partition system, comprising:
a shipping box comprising a plurality of pocket walls defining a pocket therein;
at least a portion of a track located within the pocket, the at least a portion of the track coupled to at least one pocket wall of the plurality of pocket walls; and
a door coupled with the at least a portion of the track.

2. The at least partially preassembled and packaged movable partition system of claim 1, wherein the shipping box further comprises a striker wall of the movable partition system.

3. The at least partially preassembled and packaged movable partition system of claim 1, further comprising at least one support beam within the shipping box.

4. The at least partially preassembled and packaged movable partition system of claim 1, further comprising at least one additional portion of the track separate from the at least a portion of the track and located within the shipping box.

5. The at least partially preassembled and packaged movable partition system of claim 1, further comprising a lead post within the shipping box.

6. The at least partially preassembled and packaged movable partition system of claim 5, wherein the lead post is coupled to an end of the door.

7. The at least partially preassembled and packaged movable partition system of claim 1, further comprising an automatic drive assembly comprising a motor, the automatic drive assembly mounted to at least one of the door and at least one pocket wall of the plurality of pocket walls.

8. The at least partially preassembled and packaged movable partition system of claim 7, wherein the automatic drive assembly is positioned within the door.

9. The at least partially preassembled and packaged movable partition system of claim 1, wherein the door comprises at least one sheet of panels.

10. The at least partially preassembled and packaged movable partition system of claim 1, wherein the door comprises an accordion folding movable partition including two sheets of panels.

11. A method of packaging at least a portion of a movable partition system, the method comprising:
coupling together a plurality of pocket walls to define a box comprising a pocket therein;
coupling at least a portion of a track to at least one pocket wall of the plurality of pocket walls;
coupling at least a portion of a movable partition to the at least a portion of the track and disposing the at least a portion of the movable partition within the box; and
closing the box by coupling a wall to the plurality of pocket walls defining the box.

12. The method of claim 11, wherein coupling at least a portion of a movable partition to the at least a portion of the track comprises attaching a plurality of sheets of panels to the at least a portion of the track.

13. The method of claim 11, further comprising coupling a lead post to the movable partition.

14. The method of claim 11, wherein coupling a wall to the plurality of pocket walls includes coupling a striker wall of the movable partition system to the plurality of pocket walls.

15. The method of claim 11, further comprising coupling an automatic drive mechanism to at least one of the movable partition and a pocket wall of the plurality of pocket walls prior to closing the box.

16. The method of claim 15, wherein coupling an automatic drive mechanism to at least one of the movable partition and a pocket wall of the plurality of pocket walls comprises attaching a motor of the automatic drive mechanism to at least one of the movable partition and a pocket wall of the plurality of pocket walls.

17. The method of claim 15, wherein coupling an automatic drive mechanism to at least one of the movable partition and a pocket wall of the plurality of pocket walls includes installing a motor within the movable partition.

18. The method of claim 11, further comprising disposing other components of the movable partition system within the box.

19. The method of claim 18, wherein disposing other components of the movable partition system within the box comprises disposing at least one additional portion of the track of the movable partition system within the box.

20. The method of claim 18, wherein disposing other components of the movable partition system within the box comprises disposing at least one support beam of the movable partition system within the box.

21. A method of installing at least a portion of a movable partition system in a building, the method comprising:
mounting at least a portion of a track to a wall of a box;
coupling at least a portion of a movable partition to the at least a portion of the track within the box;
shipping the box with the at least a portion of the movable partition and the at least a portion of the track therein to a building; and
securing at least a portion of the box to a wall of the building.

22. The method of claim 21, further comprising testing operation of the at least a portion of the movable partition system prior to shipping the box.

23. The method of claim 22, further comprising:
assembling at least one additional portion of the track with the at least a portion of the track of the movable partition system, wherein testing operation of the at least a portion of the movable partition system comprises extending and retracting the at least a portion of the movable partition along the track; and
detaching the at least one additional portion of the track from the at least a portion of the track while maintaining the at least a portion of the movable partition within the box.

24. The method of claim 23, further comprising disposing at least one additional component of the movable partition system within the box, the at least one additional component selected from the group consisting of at least one additional portion of the track, a support beam, an electronic control device, an elongated drive member, a battery, and hardware to be used during installation of the movable partition system.

25. The method of claim 21, further comprising disposing at least one additional component of the movable partition system in another box separate from the box, the at least one additional component selected from the group consisting of at least one additional portion of the track, a support beam, an electronic control device, an elongated drive member, a battery, and hardware to be used during installation of the movable partition system.

26. The method of claim 21, further comprising manipulating the box with a cart configured for lifting at least a portion of the box.

27. The method of claim 26, wherein manipulating the box comprises lifting at least one end of the box using a motor mounted to the cart.
